(19) United States
(12) Patent Application Publication
(10) Pub. No.: US 2026/0350958 A1
(43) Pub. Date: Nov. 5, 2026

(54) METHODS AND SYSTEMS FOR OBJECT CLASSIFICATION

(71) Applicant: Ohio State Innovation Foundation, Columbus, OH (US)

(72) Inventors: Abdollah SHAFIEEZADEH, Columbus, OH (US); Ashkan BAGHERI JEDDI, Columbus, OH (US)

(21) Appl. No.: 19/119,999

(22) PCT Filed: Oct. 13, 2023
(86) PCT No.: PCT/US2023/076819

§ 371 Date: Apr. 10, 2025

Related U.S. Application Data
(60) Provisional application No. 63/415,824, filed on Oct. 13, 2022.

(51) Int. Cl. G06V 10/25; G06N 3/0464; G06T 5/70; G06V 10/764; G06V 10/77

(52) U.S. Cl. CPC G06V 10/25; G06N 3/0464; G06T 5/70; G06V 10/764; G06V 10/7715; G06V 2201/07

(57) ABSTRACT

An example method for detecting objects in an image is described herein. The method includes receiving an input image including an object; inputting the input image into a trained deep learning model; and classifying, using the deep learning model, a state of the object. The trained learning model includes a feature extraction subnetwork including convolutional layers and pooling layers, where the feature extraction subnetwork is configured to extract first feature maps from the image, each of the first feature maps having a different resolution; a feature pyramid subnetwork including a plurality of convolutional layers, where the pyramid subnetwork is configured to receive the first feature maps from the feature extraction subnetwork and output a plurality of second feature maps; and a detection subnetwork configured receive the second feature maps from the feature pyramid subnetwork and output the state of the object.

### CROSS-REFERENCE TO RELATED APPLICATIONS

This application claims the benefit of U.S. provisional patent application No. 63/415,824, filed on Oct. 13, 2022, and titled “METHODS AND SYSTEMS FOR OBJECT CLASSIFICATION,” the disclosure of which is expressly incorporated herein by reference in its entirety.

### GOVERNMENT SUPPORT

This invention was made with government support under CMMI-2000156 awarded by the National Science Foundation. The government has certain rights in the invention.

### BACKGROUND

Unmanned aerial vehicles (UAVs) can be used to perform reconnaissance tasks. For example, UAVs with cameras can be configured to acquire photographs of a target area, that can include objects of interest to a user. There is a need for methods and systems for detecting objects in an image, and/or determining the state of those objects. In particular, methods and systems for detecting objects in images using machine learning techniques adapted to a UAV.

### SUMMARY

Methods and systems for detecting objects in an image are described herein.

In some aspects, the techniques described herein relate to a method for detecting objects in an image, the method including: receiving an input image including an object; inputting the input image into a trained deep learning model; and classifying, using the deep learning model, a state of the object, wherein the trained learning model includes: a feature extraction subnetwork including a plurality of convolutional layers and a plurality of pooling layers, wherein the feature extraction subnetwork is configured to extract a plurality of first feature maps from the image, each of the first feature maps having a different resolution; a feature pyramid subnetwork including a plurality of convolutional layers, wherein the feature pyramid subnetwork is configured to receive the first feature maps from the feature extraction subnetwork and output a plurality of second feature maps; and a detection subnetwork configured to receive the second feature maps from the feature pyramid subnetwork and output the state of the object.

In some aspects, the techniques described herein relate to a method, wherein the object is a utility pole.

In some aspects, the techniques described herein relate to a method, wherein classifying, using the deep learning model, the state of the object includes determining whether the utility pole is intact, leaning, or fallen.

In some aspects, the techniques described herein relate to a method, wherein the feature extraction subnetwork includes at least one skip connection between layers of the feature extraction subnetwork.

In some aspects, the techniques described herein relate to a method, wherein the at least one skip connection is a long connection between one of the convolutional layers and a pooling layer.

In some aspects, the techniques described herein relate to a method, wherein the at least one skip connection is a short connection between one of the pooling layers and a concatenation layer.

In some aspects, the techniques described herein relate to a method, wherein the feature extraction subnetwork includes 10 convolutional layers.

In some aspects, the techniques described herein relate to a method, wherein the feature pyramid subnetwork is configured to output the second feature maps by upsampling the first feature maps.

In some aspects, the techniques described herein relate to a method, wherein the detection subnetwork includes a classifier and a bounding box regressor.

In some aspects, the techniques described herein relate to a method, wherein the convolutional layers of the feature extraction subnetwork include separable convolutional layers.

In some aspects, the techniques described herein relate to a system for detecting objects in an image, the system including: at least one processor and a memory operably coupled to the at least one processor, wherein the memory has computer-executable instructions stored thereon that, when executed by the processor, cause the processor to execute a trained deep learning model including: a feature extraction subnetwork including a plurality of convolutional layers and a plurality of pooling layers, wherein the feature extraction subnetwork is configured to extract a plurality of first feature maps from an image; a feature pyramid subnetwork including a plurality of convolutional layers, wherein the feature pyramid subnetwork is configured to receive the first feature maps from the feature extraction subnetwork and output a plurality of second feature maps; and a detection subnetwork configured to receive the second feature maps from the feature pyramid subnetwork and output a state of the object.

In some aspects, the techniques described herein relate to a system, wherein the object is a utility pole.

In some aspects, the techniques described herein relate to a system, wherein classifying, using the deep learning model, the state of the object includes determining whether the utility pole is intact, leaning, or fallen.

In some aspects, the techniques described herein relate to a system, wherein the feature extraction subnetwork includes at least one skip connection between layers of the feature extraction subnetwork.

In some aspects, the techniques described herein relate to a system, wherein the at least one skip connection is a long connection between one of the convolutional layers and a pooling layer.

In some aspects, the techniques described herein relate to a system, wherein the feature pyramid subnetwork is configured to output the second feature maps by upsampling the first feature maps.

In some aspects, the techniques described herein relate to a method for training a deep learning model, the method including: receiving a set of digital images from a database, wherein each of the digital images is associated with a respective label; and training the deep learning model using the set of digital images, wherein the step of training includes minimizing a direct set prediction loss function.

In some aspects, the techniques described herein relate to a method, further including augmenting the set of digital images by randomly flipping a plurality of digital images from the set of digital images along an axis.

In some aspects, the techniques described herein relate to a method or claim 18, further including augmenting the set of digital images by applying a gaussian blur to a plurality of digital images from the set of digital images.

In some aspects, the techniques described herein relate to a method, wherein the direct set prediction loss function includes a bipartite matching loss and a bounding box loss.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a method of classifying the state of an object using a deep learning model, according to implementations of the present disclosure.

FIG. 2A illustrates a deep learning model, according to implementations of the present disclosure.

FIG. 2B illustrates a method of training the deep learning model illustrated in FIG. 2A.

FIG. 3 illustrates an example output image including classified objects, according to implementations of the present disclosure.

FIG. 4 is an example computing device.

FIG. 5A illustrates an example view of a leaning pole.

FIG. 5B illustrates an example view of a fallen pole.

FIG. 6 illustrates an ablation study of the components of an example implementation of the present disclosure.

FIG. 7 illustrates a comparison of an example implementation of the present disclosure to different machine learning methods.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for identifying damaged utility poles, it will become evident to those skilled in the art that the implementations are not limited thereto, but are applicable for identifying any type of object or objects in an image.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Conventional deep learning algorithms are computationally demanding. Deep learning models can include millions or billions of parameters. Each parameter requires memory to store the parameter. Additionally, various steps involved in deep learning can require significant memory to store inputs and data associated with various intermediate steps (e.g., activations) of the deep learning system. Moreover, deployment of deep learning models with a large number of parameters in scenarios that require low-latency inference can be prohibitive. Implementations of the present disclosure include lightweight AI systems and methods. As used herein, a lightweight AI system or method is an AI system or method that is optimized to reduce the computing resources required to implement the AI system or method. Lightweight AI systems and methods can be used to deploy artificial intelligence (including machine learning techniques like convolutional neural networks) in contexts with limited computing resource.

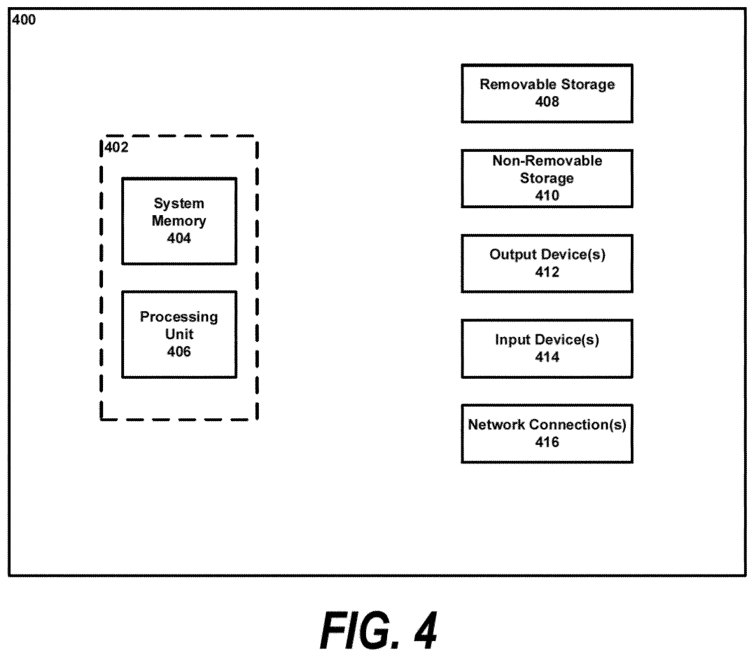

As used herein, an unmanned vehicle can refer to any kind of unmanned vehicle, uncrewed vehicle, and/or autonomous vehicle. Non-limiting example unmanned vehicles include drones, robots, probes, and any other automated system. Unmanned vehicles frequently include embedded systems. As used herein, an “embedded system” is a specialized computer system that is located onboard the unmanned vehicle to provide control and sensing to the unmanned vehicle. Embedded systems can include one or more of the components of the example computing device 400 described with reference to FIG. 4. Embedded systems often have limited computing resources and bandwidth.

As a non-limiting example, an unmanned aerial vehicle surveying a disaster area may have limited charging capabilities, limited onboard processing power and memory, and limited bandwidth available to transmit data to a remove server for analysis. Similar constraints occur in embedded systems used for many kinds of exploration and surveying.

Improved AI systems and methods can allow for improved control of autonomous vehicles. For example, an autonomous vehicle that can perform imaging and object identification using embedded systems located on the autonomous vehicle, can autonomously determine whether to take action based on the object identification, without waiting to transmit data to a server for processing, and then for instructions based on that data to be transmitted back to the autonomous vehicle. Alternatively or additionally, the improved systems and methods described herein can be used to speed up searching systems. For example, an autonomous vehicle can survey a region to count a number of objects by using embedded hardware on the autonomous vehicle for object identification. Based on the object identification (e.g., where the objects were identified, how many objects were identified, and their relative positions), the autonomous vehicle can be controlled to vary the search path or search pattern, repeat searches of certain areas, and/or expand the search to new areas based on the objects found in the already searched areas. Thus, the lightweight AI systems and methods described herein can be used for improved control of autonomous vehicles, including drones, robots, probes, and any other automated systems.

Moreover, improvements to lightweight AI systems can be used to allow non-networked devices to perform object identification for control. For example, manufacturing machinery may include cameras capable of object identification, but have limited computing resources. Systems and methods for lightweight AI systems and methods can allow for AI systems and methods to be used with these manufacturing machines. As yet another example, lightweight AI systems and methods can be used even in situations where computing resources are not severely constrained (as is often the case in embedded AI systems). Improving the efficiency of AI systems and methods can allow for more AI systems and methods to be performed, and at lower costs.

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

Described herein are systems and methods for detecting objects in an image and/or determining the states of the detected objects in an image.

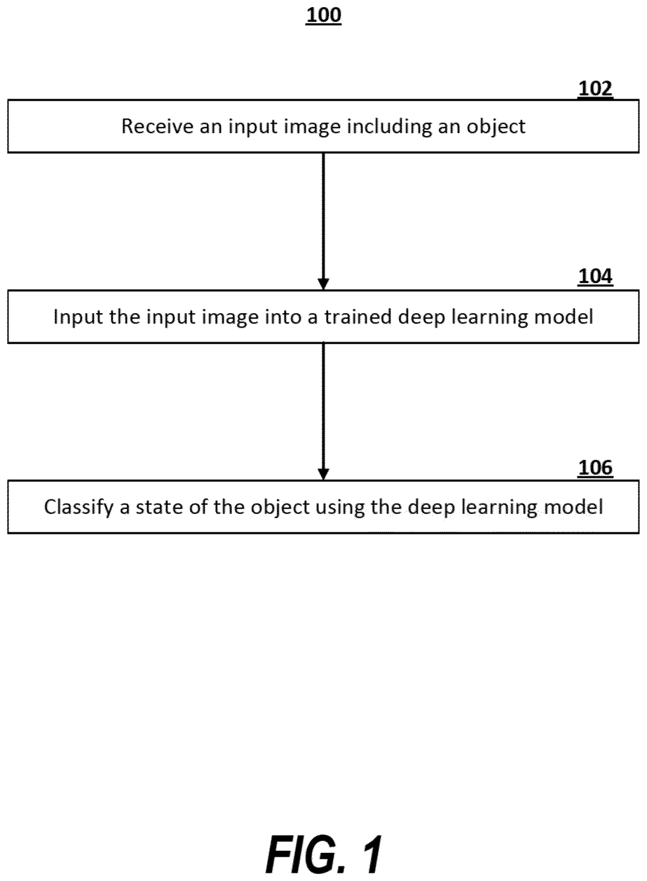

With reference to FIG. 1, a method 100 of detecting objects in an image is illustrated.

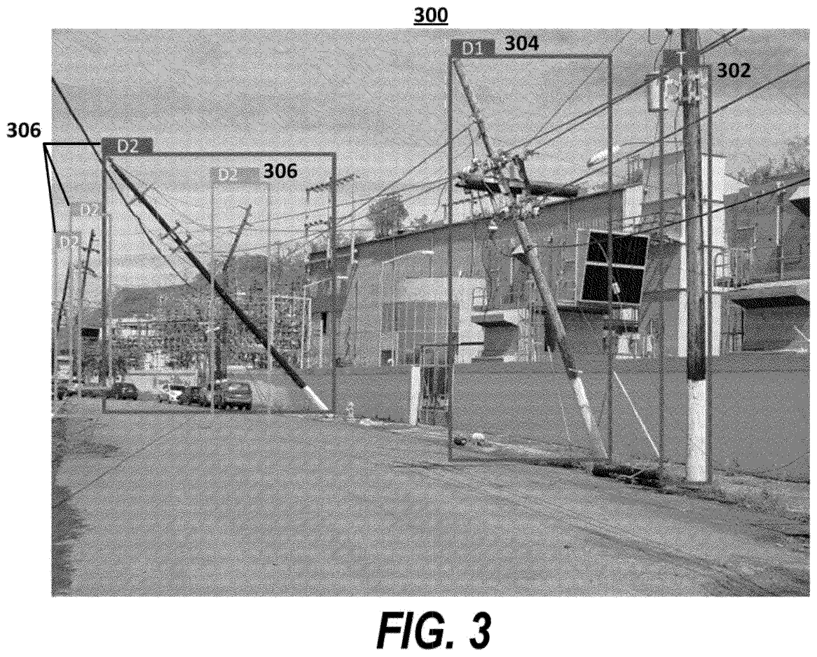

The method can include receiving 102 an input image including an object. Input images can contain any type or configuration of object. A non-limiting example object is a utility pole, and non-limiting example states of a utility pole can include “intact” (see “T” in FIG. 3), “leaning” (see “D1” in FIG. 3), and “fallen” (see “D2” in FIG. 3). It should be understood that implementations of the present disclosure can be configured to classify any type of object, and that implementations of the present disclosure can be configured to identify any number of states of the object. Additionally, it should be understood that implementations of the present disclosure can be configured to identify any number of states of an object.

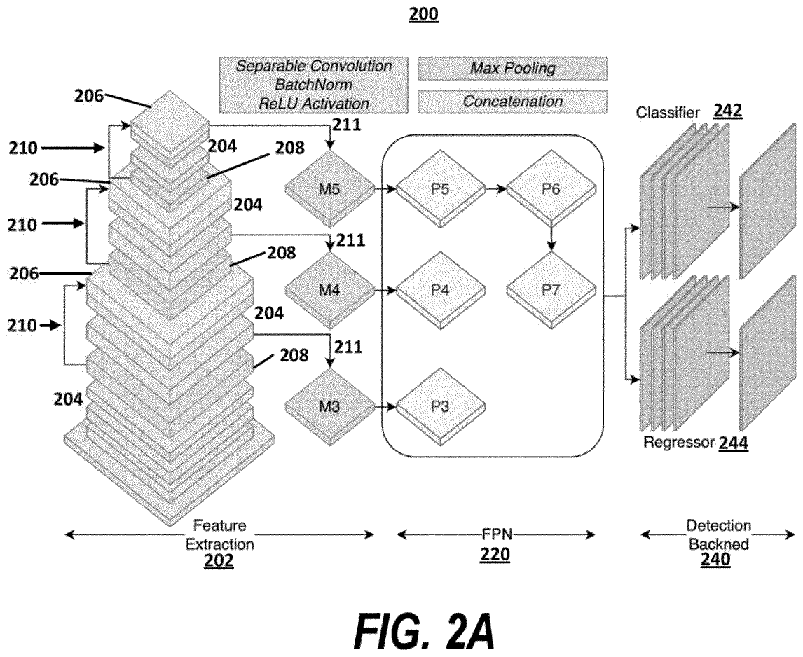

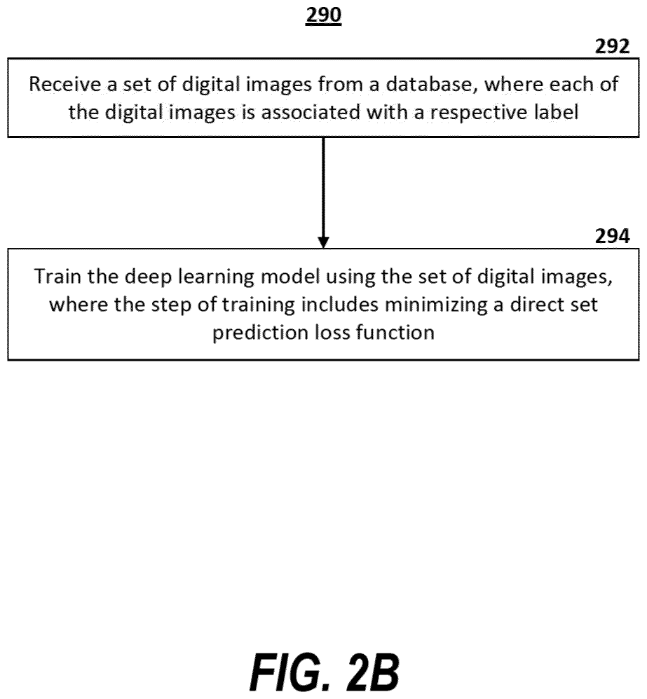

The method can further include inputting 104 the input image into a trained deep learning model. The deep learning model is described in further detail with regard to FIG. 2A and Example 1. Additionally, the method can further include classifying 106 a state of the object using the deep learning model. In implementations of the present disclosure where the object is a utility pole, classifying 106 can include determining whether one or more utility poles in the image are intact, leaning, or fallen.

With reference to FIG. 2A, an example deep learning model 200 that can be used to implement the method illustrated in FIG. 1 is shown.

The deep learning model 200 may be an artificial neural network. Optionally, as described herein, the deep learning model may be a convolutional neural network. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

A convolutional neural network (CNN) is a type of deep neural network that has been applied, for example, to image analysis applications. Unlike a traditional neural network, each layer in a CNN has a plurality of nodes arranged in three dimensions (width, height, and depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks.

It should be understood that CNNs are provided only as an example deep learning model. Machine learning models are known in the art and are therefore not described in further detail herein.

The deep learning model 200 can include a feature extraction subnetwork 202, a feature pyramid subnetwork 220, and a detection subnetwork 240. The feature extraction subnetwork 202 (also referred to herein as the “feature extraction backbone,” for example in Example 1, herein) can include one or more convolutional layers 204 and one or more of pooling layers 208. Optionally, the convolutional layers 204 are separable convolutional layers. Separable convolutional layers separate one kernel into two kernels to perform two convolutions instead of one. In the implementations described herein, the separable convolutions involve two distinct steps, i.e., a depthwise convolution followed by a pointwise convolution. The depthwise convolution involves a spatial convolution (width and height dimensions) independently over each channel (depth dimension), while the pointwise convolutions involve a 1×1 convolution to project outputs of the depthwise convolution into a new channel space. The feature extraction subnetwork 202 can be configured to extract one or more first feature maps M3, M4, M5 from the image. Optionally, each of the of the first feature maps M3, M4, M5 can have a different resolution from one another.

Optionally, the feature extraction subnetwork 202 can include at least one skip connection 210 between layers 204, 206, 208 of the feature extraction subnetwork. As used herein, a skip connection feeds an output of one layer of the network to the input of another layer of the network while skipping one or more layers of the network. An example of a skip connection is a short skip connection 210, shown in FIG. 2A. As used herein, a “short skip” connection is a connection between a concatenation layer 204 and one of the pooling layers 208. In FIG. 2A, the short skip connection 210 feeds the output of a pooling layer 208 to the input of a concatenation layer 206. Short skip connections enhance the diversity of the learned feature maps. Alternatively or additionally, the one or more one skip connections can be a long connection 211 between one of the convolutional layers 204 and a pooling layer 208. In FIG. 2A, a long skip connection 211 feeds the output of a convolutional layer 204 to the input of a pooling layer 208, i.e., the pooling layers outputting feature maps M3-M5. Long skip connections facilitate creation of a multi-scale set of features.

The present disclosure contemplates that the feature extraction subnetwork 202 can include any number of layers 204, 206, 208. As a non-limiting example, the feature extraction subnetwork 202 can preferably include 10 convolutional layers 204, which provides a powerful yet lightweight network with limiting number of parameters. For example, a feature extraction subnetwork with 10 layers of convolutional layers has been found to be the best performing model (see e.g., discussion of the performance of the example PDP-CNN implementation in Example 1). Such feature extraction subnetwork also better follows the architecture of the object detection model. It should be understood that 10 convolutional layers is provided only as an example. This disclosure contemplates providing more or less than 10 convolutional layers.

Still with reference to FIG. 2A, the feature pyramid subnetwork 220 (also referred to herein as the “FPN” or “feature pyramid network,” for example with reference to Example 1, herein) can include one or more convolutional layers 204 wherein the feature pyramid subnetwork 220 can be configured to receive one or more first feature maps M3, M4, M5 from the feature extraction subnetwork 202 and output one or more second feature maps P3, P4, P5, P6, P7. In some implementations, the feature pyramid subnetwork 220 can be configured to output the first feature maps M3, M4, M5 by downsampling. In some implementations, the feature pyramid subnetwork 220 can be configured to output the second feature maps P3, P4, P5, P6, P7 by upsampling the first feature maps M3, M4, M5. In FIG. 2A, first feature maps M3-M5 are output by respective pooling layers 208, and second feature maps P3-P7 are output by layers of the feature pyramid subnetwork 220. It should be understood that the number of first feature maps (i.e., 3) and number of second feature maps (i.e., 5) shown in FIG. 2A are provided only as an example. The feature pyramid subnetwork 220 described herein creates multi-scale feature maps, which are provided to the detection subnetwork 240.

Still with reference to FIG. 2A, the detection subnetwork 240 (also referred to herein as the “detection backend,” for example in Example 1, herein) is configured to receive the second feature maps P3, P4, P5, P6, P7 from the feature pyramid subnetwork 220 and output the state of the object. In some implementations, the detection subnetwork 240 can include a classifier 242 and/or a regressor 244. Optionally, the regressor can be a bounding box regressor.

Implementations of the present disclosure also can include systems for detecting objects in an image. In some implementations, the system can include a processor and a memory operably coupled to the processor, where the memory has computer-executable instructions stored thereon that, when executed by the processor, cause the processor to execute a trained deep learning model. The memory and processor are described with reference to the computing device 400 illustrated in FIG. 4. Optionally, the trained deep learning model can be a trained version of the model shown in FIG. 2A and described with reference to FIG. 2A.

Implementations of the present disclosure include methods for training deep learning models, including the deep learning model 200 illustrated in FIG. 2A. FIG. 2B illustrates a method 290 for training a deep learning model. The method can include receiving 292 a set of digital images from a database, where each of the digital images is associated with a respective label. Optionally, the method can include augmenting the set of digital images by randomly flipping a plurality of digital images from the set of digital images along an axis. Alternatively or additionally, the set of digital images can be augmented by applying a gaussian blur to a plurality of digital images from the set of digital images.

The method can also include training 294 the deep learning model using the set of digital images, where the step of training comprises minimizing a direct set prediction loss function. Optionally, the direct set prediction loss function can include a bipartite matching loss and/or a bounding box loss.

As a non-limiting example application, the systems and methods described with reference to FIGS. 1-2B can be used to perform classification of utility poles in images taken by an UAV after a natural disaster. UAVs can be subject to weight, power, and size requirements, as described herein. The systems and methods described herein can be used to perform classification of objects with fewer computing resources, and therefore can be beneficial for UAV applications.

FIG. 3 illustrates a picture 300 of storm damage classified by an example implementation of the present disclosure. The intact utility poles, leaning utility poles, and down utility poles are bounded by boxes 302, 304, 306 based on the output of the example implementation. The “T” box 302 shows a utility pole classified as intact. The D1 box 304 shows a utility pole classified as leaning. The “D2” boxes 306 show utility poles classified as down.

It should be appreciated that the logical operations described herein with respect to the various figures may be implemented (1) as a sequence of computer-implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well-known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media and non-removable media implemented in any method or technology for storage of information such as computer-readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### Example 1

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

Implementations of the present disclosure include systems and methods configured for performing analysis of disaster-stricken areas using UAVs. While the example implementation is described in the example context of using UAVs to identify power poles in various states of damage, it should be understood that implementations of the present disclosure can be used for any kind of object identification using any kind of imaging data.

UAVs equipped with cameras provide capabilities for reconnoitering disaster-stricken areas. Deep learning-based computer vision algorithms enable analysis of the captured images and detection of damages to the built environment. When such analyses are conducted on-board in UAVs, they can provide real-time actionable information that is critical for the accelerated restoration of systems. However, conventional deep learning algorithms are computationally demanding. Moreover, deployment of deep learning models with a large number of parameters in scenarios that require low-latency inference is prohibitive. To address this fundamental gap, implementations of the present disclosure include an efficient deep learning-based computer vision model of power distribution poles damage detection that is capable of on-board deployment in UAVs.

The implementation of the present disclosure described with reference to the present example includes a lightweight convolutional neural network (CNN) architecture, referred to herein as “PDP-CNN.” PDP-CNN can include multi-scale feature operations and anchor-less object detection. In a study of the example implementation, the model was applied to a dedicated image database from post-hurricane reconnaissance in power distribution poles. Results of extensive experiments show that PDP-CNN is capable of achieving high throughput, competitive accuracy, and efficient memory utilization on power-constrained embedded systems.

Extreme weather events can pose significant risks to the reliability and resilience of power systems, resulting in tens of billions of dollars in economic damage annually and adverse public health impacts [1]. According to the North American Electric Reliability Corporation (NERC), a third of all sustained outages in medium and high voltage systems in the period of 2013-2018 were caused by weather-related events [1]. Moreover, a recent analysis of power outage data collected by the US Department of Energy (DOE) reveals a 67% increase in major power outages from weather-related events since 2000 [2].

Overhead power distribution systems are highly vulnerable to high-wind hazards [3]. In fact, high wind-induced outages in distribution systems account for over 92% of electric service interruptions in the US [4]. The extensive failures in power distribution systems in the aftermath of extreme events often lead to prolonged power outages. For example, full restoration of the grid post Hurricane Maria in 2017 took nearly 10 months [5]. Similarly, nearly 800,000 customers experienced a 10-day long blackout during Superstorm Sandy in 2012 [6]. The high vulnerability of our overhead distribution systems and the significant socio-economic costs of prolonged outages underpin the critical importance of improved grid resilience, where consumers' access to electricity is restored rapidly post disasters. The critical importance of achieving climate resilience is not lost on the current administration as evidenced by the DOE's new Building a Better Grid Initiative, investing $2.3 billion to strengthen the grid against extreme weather [7].

Control-based strategies such as dispatch of restoration crew, network reconfiguration, and deployment of distributed generation units [8] are often leveraged to enhance the resilience of power systems during disruptions. Besides these control-based strategies, prompt assessment of physical damages to components in the aftermath of extreme weather and climate events such as hurricanes can facilitate rapid power restoration. Specifically, analysis of the collected damage data enables fault detection. Although these methods can help reduce the overall equipment downtime, they cannot accurately pinpoint the location of the fault, and the type and degree of sustained damages. Moreover, data acquisition systems are prone to failure during extreme events, leaving the possibility that faults may not be reliably detected.

Visual inspection of the power equipment also provides valuable information about characteristics of physical damage. Several methods of visual inspection have been employed by utility companies during extreme events. Manual reconnaissance (i.e., foot patrol) is the most common method, where a group of experienced inspectors visits impacted regions and document incurred damages. Although foot patrol has been commonly used for post-disaster reconnaissance, the impacted regions in most cases are not readily accessible due to varying degrees of failures in transportation systems as well as safety concerns to inspectors posed by potentially live conductors. UAVs are a favorable alternative in these conditions. Deployment of UAVs has recently gained attention for damage assessment and monitoring of infrastructure systems [9], [10] due to their high maneuverability, ability for remote control, and lower cost relative to conventional reconnaissance strategies.

UAV-captured imagery and deep learning-based computer vision can be used for rapid autonomous damage assessment in power distribution and transmission systems. [11-14].

Training convolutional neural network architectures—such as the ones employed in the existing literature-requires GPUs with high computing power and memory resources. In lieu of these resources on reconnaissance sites, training and evaluation of computer vision models are often carried out after transferring the imagery dataset off-site to cloud datacenters. However, data transfer between the cloud and an edge device requires a reliable wireless internet connection with high bandwidth. This prohibits the use of cloud processing units for reconnaissance in regions struck by natural hazards with limited connectivity. In these situations, relatively powerful embedded systems are a favorable alternative for real-time analysis of data real-time. However, it can be impractical to deploy deep neural network architectures on resource-constrained embedded systems. In particular, the size of conventional models which is greatly larger than the on-chip local storage prohibits such applications. More importantly, large networks cannot be employed on low-power UAV-mounted embedded platforms due to their high power consumption. Reducing the number of learnable parameters by pre-training computer vision models is often selected as a remedy to this issue. A shortcoming of this approach is poor detection performance in object-specific tasks as a result of transferring weights learned on generic object detection datasets.

The example implementation of the present disclosure includes an efficient CNN approach, referred to herein as “PDP-CNN,” specifically designed for damage detection and classification of distribution poles from post-hurricane reconnaissance imagery data at the edge. In particular, as the architecture of object detection models has a significant influence on both their accuracy and computational efficiency, the example implementation can include an architecture that enables real-time perception capabilities at the edge. Furthermore, as described herein, the example implementation can optionally include a new feature extraction backbone, feature pyramid network and/or a detection backend. The example implementation of the present disclosure can optionally include any or all of the following features: a novel deep learning-based computer vision model suitable for deployment on resource-constrained embedded systems such as unmanned aerial vehicles; a lightweight yet effective feature extraction backbone that leverages separable convolutions, short and long dense-like connections, and feature pyramid networks; and/or anchor-free detection heads that remove the need for postprocessing steps such as non-maximum suppression. The study described herein validated that the example implementation included computational efficiency and competitive performance of the developed model compared to state-of-the-art computer vision models.

Deep learning-based object detection methods can be classified into two major categories: region-proposal-based methods and classification-based methods. Region proposal-based models can require a discrete step designed for region proposal. Classification-based methods can include a single CNN for acquisition of representative features and localizing the objects of interest.

Region Proposal-based Methods: The family of region-based convolutional neural networks including R-CNN, Fast R-CNN, and Faster R-CNN [15] belongs to the class of region proposal-based methods. These methods essentially decompose the process of object detection into two discrete stages and design separate algorithms for each stage. The first stage in this process consists of extracting regions of interest, i.e., regions of proposals. This stage is followed by a separate network that is responsible for the classification of each region proposal as well as predicting the bounding box. Typically, the first stage of region proposal-based methods is the computational bottleneck of these object detection algorithms. Faster R-CNN alleviates this issue by developing a region proposal network (RPN) which is a fully convolutional network. RPN shares full-image convolutional features with the detection network used in the second stage of detection and therefore enables nearly cost-free region proposals. Despite major advancements offered by methods such as Faster RCNN, generating a large number of region proposals and classifying each region during inference is a computationally demanding process that introduces significant delays [16]. For this reason, classification-based detection methods have gained attention. The example implementation focuses on classification-based detector networks due to their desirable trade-off between accuracy and computational cost which can make them more suitable for deployment on low-power and resource-constrained embedded systems, however it should be understood that other implementations can use other types of networks in addition to, or in place of, classification-based detector networks.

Single-shot detectors: Single-shot detectors such as different variations of YOLO [17] and SSD [18] combine the distinct components of region proposal-based methods into a unified single neural network. Through this process, the features of the input image are directly used for both classification and regression of the bounding boxes. In particular, YOLO uses a spatial grid over the input image and estimates bounding box coordinates along with the object label and the presence probability of the object. The architecture of YOLO models is inspired by GoogleNet and has a total of 24 convolutional layers with two fully connected layers at the end. Despite the computational advantage of YOLO, their major drawback is that they are limited to detecting only a single object in each grid. On the other hand, SSD network uses convolutional layers of varying sizes and computes multiscale feature maps which in turn produces the bounding box and class predictions.

CNN networks commonly consist of a stack of convolutional layers with the purpose of performance enhancement. VGG [19] expanded the depth of CNN models and introduced a variant of the model with 13 convolutional layers and 3 fully connected layers as VGG-16 and a deeper variant with 3 additional convolutional layers as VGG-19. To overcome the limitations of the conventionally used CNN architectures in the selection of kernel sizes, inception networks were introduced [20]. Inception networks leveraged kernels of multiple sizes to develop an inception module which results in a wide rather than a deep network. Besides the limitation on the selection of kernel sizes, extremely deep neural networks often suffer from vanishing and exploding gradients. Skip connections (e.g., the skip connections 210 shown in FIG. 2A) can be used to remedy these problems. [21]. Through this modification, the activations of one layer are directly fed into another deeper layer to explicitly let these layers fit a residual mapping. This resulted in the introduction of the residual blocks that prevent performance reduction in deep networks.

The PDP-CNN architecture described herein can include three main components: a feature extraction backbone, a feature pyramid network, and an anchor-free detection backend. The feature extraction backbone features a set of properties to achieve state-of-the-art performance and accurate representations while minimizing the computational cost for application in resource-constrained embedded systems. These features include separable convolutions, long skip connections (e.g., the long skip connections 211 shown in FIG. 2A) between layers with the aim of creating a multi-scale set of features as well as short connections to enhance the diversity of learned feature maps. The FPN module merges the feature maps extracted by the backbone in a top-down manner from coarsest to finest and generates multi-scale feature maps. Subsequently, the pyramid features are fed into the designed detection backend which consists of two separate subnets for object detection and bounding box regression. To further enhance the computational efficiency, optionally the detection backend can be configured so that it does not require anchors for bounding box predictions. In addition to the PDP-CNN architecture, the example implementation includes a direct set prediction loss function that includes two major components: a bipartite matching loss and a bounding box loss to improve localization. FIG. 2A illustrates the overall architecture of an example deep learning model 200, including an example implementation of the PDP-CNN model.

The performance of deep learning-based object detection algorithms can depend on the quality of representations learned by the feature extraction layers. Besides the importance of these layers in achieving high detection accuracy, the architecture of feature extraction layers also impacts inference performance in terms of throughput. Feature extraction networks with fewer parameters can exhibit lower memory utilization and consequently lower power consumption. Therefore, given the significant influence of feature extraction layers on the overall performance of detection models as well as the resources consumed by these layers, the example implementation can use a powerful yet lightweight network with a limited number of parameters. With these considerations, the example implementation uses 10 convolutional layers as the feature extractor in the PDP-CNN backbone. It should be understood that 10 convolutional layers are provided only as an example, and that other numbers of layers can be used.

Inspired by the performance of separable convolutions [24], the example implementation can explicitly factor regular convolution into distinct steps of a depthwise convolution followed by a pointwise convolution. Depthwise convolutions perform a spatial convolution independently over each channel of input. In addition, pointwise convolutions perform a 1×1 convolution and project the outputs of the depthwise convolution onto a new channel space. Progressive downsampling is essential for the reduction of memory usage and computational cost in the development of efficient object detection algorithms. However, in order to maintain the localized information on foreground objects for detection networks throughout the feature extraction layers, excessive downsampling should be avoided. The study empirically achieves a desirable trade-off between preservation of localized feature points and computational efficiency. In this context, the initial convolutional layer in the PDP-CNN backbone (e.g., the feature extraction subnetwork 202 shown in FIG. 2A) may only downsample the input image by a factor of 2 using strided convolutions in some implementations of the present disclosure. Furthermore, in the first block of layers, the first convolutional layer and the other three have 64 and 32 kernels, respectively and with a kernel size of 5×5. Other convolutional layers employ kernels with a size of 3×3 with an increasing number of filters of up to 256. The number of kernels can be limited in order to achieve higher performance in the first few layers where the resolution of the feature map is extremely high.

In order to facilitate a fluent flow of gradients and feature propagation between the layers of PDP-CNN and to avoid problems such as vanishing or exploding gradients, the example implementation can include short dense-like connections after concatenation layers (e.g., the concatenation layers 206 shown in FIG. 2A) and long dense-like connections placed between pooling and every other convolutional layer. This design further builds a more diverse set of visual features. Despite the high accuracy of DenseNet architectures, a major drawback of these networks is the progressive increase of their computational demand as the number of dense connections increases [25]. In order to alleviate this issue, the example implementation of PDP-CNN can optionally be configured with only a selection of short and long connections instead of using the feature maps of all preceding layers as inputs. Based on the selected arrangement of the layers in the backbone architecture, the example implementation can optionally include a connection at every other block of convolutional layers. Moreover, a channel-wise concatenation merges the feature maps that are obtained from the preceding pooling layer (e.g., the pooling layer 208 shown in FIG. 2A).

FPN provides a top-down pathway to construct higher resolution layers from a semantically richer layer. To augment extracted feature maps and create multi-scale feature pyramids, the example implementation can extract feature maps M3, M4, and M5 and note the downsampling rate of 2^{I} where I denotes the index of the feature map. Accordingly, feature maps P3, P4, and P5 are created using upsampling. In addition, P6 and P7 are built using a convolution with a stride of two. Ultimately, these feature maps, i.e., P3 through P7 are passed to the detection backend.

The example implementation can further include an anchor-free detection backend that does not assume predefined anchors during the training process. In this process, the points on extracted feature maps throughout the FPN are labeled with positive or negative classes considering the sampling rate of 2. For anchor-based object detection algorithms, if the anchor falls in a ground truth box, and the intersection-over-union (IoU) metric is larger than a fixed threshold, the example implementation can label the point as positive and otherwise negative. Similarly, the example implementation can assume that the point (x,y) on the input image falls in a ground truth box with center coordinates of (x_g,y_g),w as the width, and h as the height. The example implementation can define (a_1,a_2,a_3,a_4) as the distance of point (x,y) from the four sides of the ground truth box, i.e., left, top, right, and bottom, respectively. Then, the example implementation can define a projected box with center point (x,y) and distances (b_1,b_2,b_3,b_4). Based on this definition, b_1 and b_3 are the average of a_1 and a_2, and similarly b_2 and b_4 are defined with respect to a_2 and a_4. Next, the intersection and union between these two boxes with distance sets of a and b are calculated and IoU is determined. Finally, the points on feature maps are labeled based on this value. Through this process, the example implementation can remove the need for predetermined anchor boxes and their corresponding computational complexity. It is worth noting that there can still exist a threshold for the labeling process similar to the anchor-based methods.

Separate fully convolutional subnetworks are ubiquitously employed in the literature as detection heads for classification and regression tasks (e.g., [27]). Adopting this scheme, the example implementation can include a detection head that consists of two subnetworks with four convolutional layers and 256 filters of the size of 3×3. Following these layers, the classifier subnetwork (e.g., the classifier 242 shown in FIG. 2A) can have a convolutional layer with a kernel size of 3×3 and K filters, where K represents the number of target classes. On the other hand, the regressor subnetwork (e.g., the regressor 244 shown in FIG. 2A) adopts 4 filters with the same size, where the four outputs represent the bounding box (a₁, a₂, a₃, a₄). The two subnetworks can optionally not share weights despite their architectural similarity. The weights corresponding to each subnetwork can shared between features P3 through P7 that are extracted from the FPN model.

In order to learn the task of distribution pole detection in an end-to-end fashion, the example implementation can include a set prediction loss function. The loss function can optionally include two components: bipartite matching loss and bounding box loss.

Bipartite Matching Loss: After passing through the detection backend, PDP-CNN makes N predictions where N represents the number of classes. Let y be the number of ground truths in the image, and

$$\hat{y} = {\{ {\hat{y}}_{i} \}}_{i = 1}^{N}$$

_be the the N predictions of the network where ŷ=(ĉᵢ,bᵢ) is the tuple consisting of the predicted class and a bounding box bᵢ=(x̅ᵢ,y̅ᵢ,wᵢ,hᵢ) where (x̅ᵢ,y̅ᵢ) represents the midpoint of the bounding box, and wᵢ and hᵢ are the width and height of the bounding box, respectively. PDP-CNN finds a bipartite matching between these two sets of y and ŷ using a matching function across a permutation of N elements, σ∈S_{N}, with the lowest cost as follows:

$$\hat{σ} = arg {min}_{σ ∈ {𝒮}_{N}} {\sum }_{i}^{N} {ℒ}_{match} ( {y}_{i} , {\hat{y}}_{σ ( i )} )$$

where L_{match} is a pair-wise matching cost between ground truth yᵢ and prediction with index σ(i). The matching cost accounts for both the class prediction and the similarity of predicted and ground truth boxes. For the prediction with index σ(i), the probability of class cᵢ is defined as \hat{p}_{σ(i)}(cᵢ) and the predicted box as \hat{b}_{σ(i)}. The matching cost therefore is then defined as:

$${ℒ}_{match} ( {y}_{i} , {\hat{y}}_{σ ( i )} ) = - {\text{?}}_{\{ {c}_{i} \neq ∅ \}} {\hat{p}}_{σ ( i )} ( {c}_{i} ) + {\text{?}}_{\{ {c}_{i} \neq ∅ \}} {ℒ}_{box} ( {b}_{i} , {\hat{b}}_{σ ( i )} )$$

The second step is to compute the loss function, which consists of the Hungarian loss for all pairs matched in the previous step. The loss is defined similar to the losses of common object detectors as a linear combination of a negative log-likelihood for class prediction and a bounding box loss:

$${ℒ}_{Hungarian} ( {y}_{i} , {\hat{y}}_{i} ) = {\sum }_{i = 1}^{N} [ - log {\hat{p}}_{{\hat{σ}}_{( i )}} ( {c}_{i} ) + {\text{?}}_{\{ {c}_{i} \neq ∅ \}} {ℒ}_{box} ( {b}_{i} , {\hat{b}}_{\hat{σ} ( i )} ) ]$$

where \hat{σ} is the optimal assignment computed in the first step via Eq. (1).

Bounding Box Loss: Another term in the loss function is the bounding box loss which estimates a score for the predicted bounding boxes. As described herein, a linear combination of the l₁ loss and the generalized IoU loss L_{IoU} that is scale-invariant is used as

$${ℒ}_{box} = {λ}_{IoU} {ℒ}_{IoU} ( {b}_{i} , {\hat{b}}_{σ ( i )} ) + {λ}_{{l}_{1}} ‖ {b}_{i} - {\hat{b}}_{σ ( i )} ‖$$

where λ_{IoU} and λ_{I}_{₁} are hyperparameters. The bounding box loss function helps to predict the box directly without any anchor reference or scaling issue. These two losses are normalized by the number of objects inside the batch.

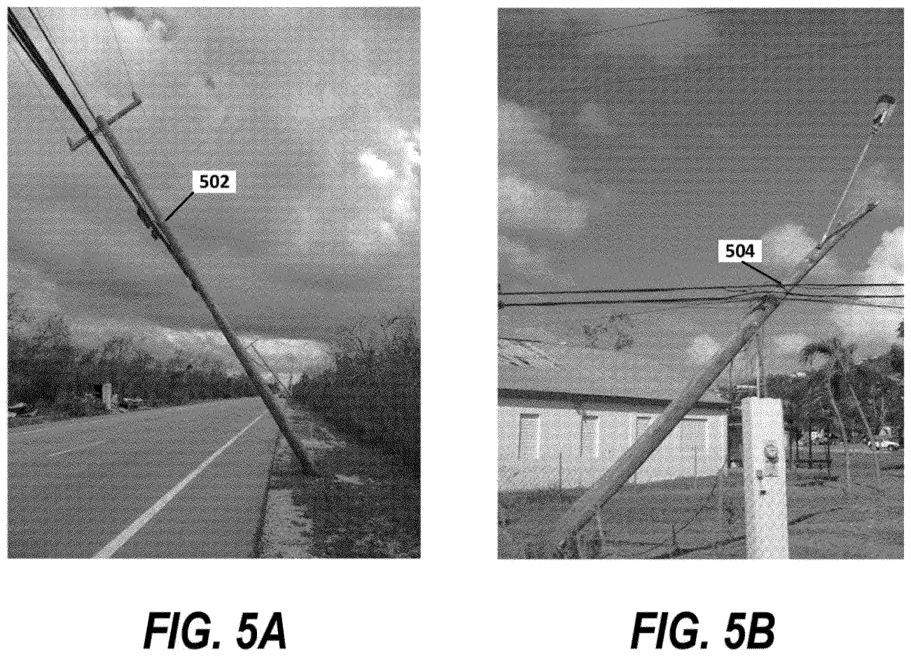

The study used a post-hurricane reconnaissance imagery dataset collected by the StEER group of inspectors through both single-camera shots of utility poles and streetlevel imagery. After processing the street-level imagery and extracting all recorded distribution poles, the repository of images consists of 3182 poles that are acquired in the aftermath of three hurricane events (Irma 2017, Maria 2017, and Michael 2018) as well as an archive of past events [29]. A small set of damaged distribution poles (53 cases) is accompanied by a description reporting the state of the pole as one of the classes of intact, leaning, and fallen. In this study, these three classes of intact, learning, and fallen are hereinafter referred to as T,D1, and D2, respectively. Missing damage categories are manually annotated by the authors complying with the visual characteristics of the already labeled images by the inspectors. A sample leaning pole 502 is shown in FIG. 5A, and a sample fallen pole 504 is shown in FIG. 5B.

The study applied a scale augmentation to the input images in this study to a minimum and maximum dimension of 600 and 1024 pixels, respectively while keeping the original aspect ratio. The input images were horizontally flipped randomly with a probability of 0.5 as part of the data augmentation. Furthermore, in order to account for the variation in lighting conditions of the images, the study applied a color jittering that randomly changes the brightness, contrast, saturation, and hue of an image. Optionally, the example implementation can account for the potential low quality of the captured images by the embedded systems by randomly blurring the images through a Gaussian blur.

The studying included dividing the labeled dataset of utility poles into parts containing 20%, 20%, and 60% of the size of the dataset and using them for training, validation, and testing, respectively. The purpose of defining a validation set can be to tune the hyper-parameters of the PDP-CNN model via cross-validation. In the study, no repetitive sample was used in splitting the dataset for validation, and the evaluation metrics obtained through the cross-validation folds were averaged to produce a single-point estimate. In addition, the training data have imbalanced representation from different classes, with the intact class having the largest number of datapoints, which can potentially induce a prediction bias towards the over-represented class of intact utility poles. To mitigate this problem, class-specific weights are assigned to the loss function so to impose an additional penalty for misclassifying an under-represented class [15]. The PDP-CNN model is trained with AdamW. The initial learning rate is set to 10⁻⁵ for the CNN model. Furthermore, a weight decay of 10⁻⁴ is applied to gradually reduce the learning weight along training epochs. The weights are initialized via Xavier initialization.

The example implementation was evaluated using various metrics in the study.

Mean Average Precision (mAP): Precision and recall are two of the most common performance evaluation metrics that are inversely related. Therefore, impartial comparison between object detection methods is conventionally carried out without solely relying on either of these metrics. Alternatively, the area under the precision-recall curve is defined as average precision (AP). In the case of multi-class object detection tasks such as the problem in this study, mean average precision (mAP) is reported which is defined as the mean of AP values in the detection of individual classes.

Intersection over union (IoU): Intersection over union (IoU) is a well-established and common evaluation metric in anchor-based object detection methods. IoU investigates the similarity between arbitrary shapes. In the case of object detection, IoU is defined as the ratio of the area of overlap to the area of the union between the ground truth and estimated bounding boxes.

False positive per image (FPPI): FPPI is defined as the ratio of predicted false positives and the total number of images.

Miss rate (MR): MR is defined as the ratio between the number of missed objects and the total number of samples belonging to the same class.

Frames per Second (FPS): FPS is defined as the number of images that can be processed by the object detection model in a second during the inference phase (i.e., the rate of processing images).

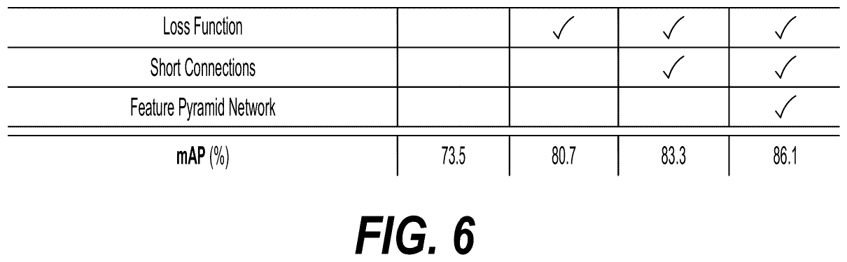

The study included an example ablation study to determine the contribution of building blocks of PDP-CNN in its performance in terms of mAP. Four variants of the model are considered in this analysis and the results are shown in FIG. 6. The first variant of the model removes the loss function definition by performing a regression to estimate the bounding box coordinates. This base model further removes the defined short skip connections in the feature extraction backbone as well as the FPN and its long connections. Therefore, this model does not leverage diverse and semantically rich feature maps otherwise offered by PDP-CNN and can only achieve a mAP of 73.5%. The second variant uses the defined bipartite matching loss and bounding box loss and therefore investigates the contribution of the loss function formulation in the performance of PDP-CNN. As can be seen in FIG. 6, the introduced loss function significantly improves the performance of PDPCNN in object localization and classification by 7.6%. To evaluate the significance of diverse feature maps, the study adds another variant that employs short skip connections as well as the defined loss function. This addition has resulted in a 1.8% increase in mAP. Finally, the last variant in this ablation study employs all features of the full PDP-CNN model and shows a mAP of 86.1%. This observation highlights the significance of using multi-scale feature maps which is mainly attributed to the presence of objects with different scales in a single image similar to FIG. 3.

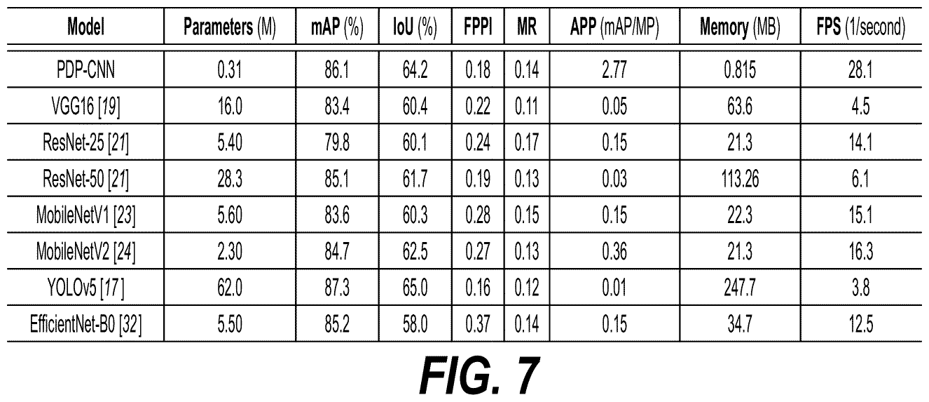

FIG. 7 illustrates the overall performance of PDP-CNN in the detection and classification of the damages in power distribution poles. The study compared the performance with a variety of state-of-the-art CNN benchmark architectures where all models are initialized with MSCOCO pre-trained weights, and the same PDP-CNN training framework as described herein. This comparison also includes EfficientNet [32] in addition to other architectures described herein. EfficientNet introduces the idea of utilizing an effective compound coefficient to scale up CNNs. This model has shown state-of-the-art accuracy on benchmark datasets while decreasing the number of parameters by 20 times. In overall, the selected benchmark architectures are the most commonly used and well-established models in the field of object detection.

As can be seen in FIG. 7, the example implementation including a PDP-CNN backbone achieves an mAP of 86.1% which means that PDP-CNN is the second-best detection model, following YOLOv5 only by 1.2%. Moreover, in addition to the evaluation metrics defined earlier, the study can use an accuracy contribution per parameter (APP) as a metric to quantify the contribution of parameters in the model in achieving high accuracy. This metric is defined as the ratio between an accuracy-related metric-mAP in this study- and the number of parameters in million. Based on APP, despite better mAP of YOLOv5, it suffers from poor memory utilization and therefore it achieves a significantly less APP compared to PDP-CNN. In fact, YOLOv5 is the largest CNN architecture among the benchmark architectures used in this analysis as it has the largest number of parameters. On the other hand, PDP-CNN exhibits an impressive APP value of 2.77 while all other models have an APP value of less than 1. This is further translated to the high FPS of PDP-CNN which is the highest among benchmark models. In terms of false positives and miss rate, PDP-CNN shows a performance similar to the other benchmark architectures. Contrary to large networks such as YOLOv5 and VGG16, PDP-CNN achieves high mAP through short skip connections, feature pyramid network, and anchor-free detection backend that result in more diverse and multi-scale feature maps. This demonstrates the effectiveness of the designed architecture.

FIG. 3 shows the detected and classified distribution poles in one of the test sample images. FIG. 3 illustrates the performance of PDP-CNN in the detection, localization, and classification of poles (see “T” in FIG. 3), “leaning” (see “D1” in FIG. 3), and “fallen” (see “D2” in FIG. 3. As can be seen in FIG. 3, many poles are located in the background of the closer poles and show significant overlap. Even in this complex sample, the example implementation of PDP-CNN identified and classified poles with multiple classes and at a far distance from the point where the image was captured.

The present disclosure contemplates that the example implementation can be used with unmanned aerial vehicles. UAVs can cruise autonomously and acquire critical visual information about the infrastructure. An autonomous damage detection model, including the models described herein, can subsequently facilitate rapid evaluation of the damaged assets. The example implementation includes a deep learning-based computer vision approach for rapid damage assessment of utility poles in the wake of hurricane events. In the broader domain of computer vision, this problem is regarded as an object detection problem. Although many object detection algorithms have been proposed in the literature, the inference phase of these methods when deployed on resource-constrained embedded platforms such as on-edge devices mounted on UAVs is time- and resource-consuming and therefore is impractical. To overcome these performance-limiting disadvantages, the example implementation includes a lightweight deep learning-based computer vision model called PDP-CNN. PDP-CNN consists of a specially designed feature extractor with short dense connections, a feature pyramid network that leverages multi-scale feature maps, and an anchor-free detection backend. The study conducted training, validation, and testing of the PDP-CNN model using a post-hurricane reconnaissance imagery data acquired by structural extreme events reconnaissance (StEER) from over three historic hurricanes. Three damage categories of intact, leaning, and fallen were defined for the distribution poles. The results from performance evaluation on the test dataset showed that the proposed PDP-CNN architecture provides an accuracy on par with state-of-the-art object detection methods while substantially outperforming these methods in terms of throughput. The outcomes of this study can facilitate rapid autonomous damage assessment of distribution poles and enhance the resilience of power distribution systems. The developed methodology can be extended for the detection of damage in other key assets of power distribution and transmission systems and other hazards.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] Executive Office of the President, “Economic Benefits of Increasing Electric Grid Resilience to Weather Outages,” IEEE USA Books & eBooks, 2013.
[2] Climate Central, “Power OFF: Extreme Weather and Power Outages Climate Central,” September 2020.
[3]T. Gwaltney, “Florida Power & Light Company Grid Hardening and Hurricane Response,” United States Department of Energy, p. 22, 2018.
[4] United States Government Accountability Office (GAO), “Electricity and grid resilience: Climate change Is expected to have far-reaching effects and DOE and FERC should take actions,” GAO-21-423T, no. GAO-21-423T, 2021.
[5]A. Kwasinski, F. Andrade, M. J. Castro-Sitiriche, and E. O'Neill-Carrillo, “Hurricane maria effects on puerto rico electric power infrastructure,” IEEE Power and Energy Technology Systems Journal, vol. 6, no. 1, pp. 85-94, 2019. Publisher: IEEE.
[6]P. Hoffman and W. Bryan, “Comparing the impacts of northeast hurricanes on energy infrastructure,” Office of Electricity Delivery and Energy Reliability, US Dept. of Energy, Washington, D C, 2013.
[7] Department of Energy (DOE), “Biden Administration Launches $2.3 Billion Program to Strengthen and Modernize America's Power Grid,” April 2022.
[8]N. L. Dehghani and A. Shafieezadeh, “Multi-stage Resilience Management of Smart Power Distribution Systems: A Stochastic Robust Optimization Model,” IEEE Transactions on Smart Grid, 2022. Publisher: IEEE.
[9]H. Zhang, L. Wu, Y. Chen, R. Chen, S. Kong, Y. Wang, J. Hu, and J. Wu, “Attention-Guided Multitask Convolutional Neural Network for Power Line Parts Detection,” IEEE Transactions on Instrumentation and Measurement, vol. 71, pp. 1-13, 2022. Publisher: IEEE.
[10]R. Jenssen and D. Roverso, “Intelligent monitoring and inspection of power line components powered by UAVs and deep learning,” IEEE Power and energy technology systems journal, vol. 6, no. 1, pp. 11-21, 2019. Publisher: IEEE.
[11]M. M. Hosseini, A. Umunnakwe, M. Parvania, and T. Tasdizen, “Intelligent damage classification and estimation in power distribution poles using unmanned aerial vehicles and convolutional neural networks,” IEEE Transactions on Smart Grid, vol. 11, no. 4, pp. 3325-3333, 2020. Publisher: IEEE.
[12]J. Kim, M. Kamari, S. Lee, and Y. Ham, “Large-scale visual data-driven probabilistic risk assessment of utility poles regarding the vulnerability of power distribution infrastructure systems,” Journal of Construction Engineering and Management, vol. 147, no. 10, p. 04021121, 2021. Publisher: American Society of Civil Engineers.
[13]X. Zhang, Y. Zhang, J. Liu, C. Zhang, X. Xue, H. Zhang, and W. Zhang, “InsuDet: A fault detection method for insulators of overhead transmission lines using convolutional neural networks,” IEEE Transactions on Instrumentation and Measurement, vol. 70, pp. 1-12, 2021. Publisher: IEEE.
[14]L. She, Y. Fan, J. Wang, L. Cai, J. Xue, and M. Xu, “Insulator surface breakage recognition based on multiscale residual neural network,” IEEE Transactions on Instrumentation and Measurement, vol. 70, pp. 1-9, 2021. Publisher: IEEE.
[15]S. Ren, K. He, R. Girshick, and J. Sun, “Faster r-cnn: Towards real-time object detection with region proposal networks,” Advances in neural information processing systems, vol. 28, 2015.
[16]Z.-Q. Zhao, P. Zheng, S.-t. Xu, and X. Wu, “Object detection with deep learning: A review,” IEEE transactions on neural networks and learning systems, vol. 30, no. 11, pp. 3212-3232, 2019. Publisher: IEEE.
[17]G. Jocher, A. Chaurasia, A. Stoken, J. Borovec, NanoCode012, Y. Kwon, TaoXie, J. Fang, imyhxy, K. Michael, Lorna, A. V, D. Montes, J. Nadar, Laughing, tkianai, yxNONG, P. Skalski, Z. Wang, A. Hogan, C. Fati, L. Mammana, AlexWang1900, D. Patel, D. Yiwei, F. You, J. Hajek, L. Diaconu, and M. T. Minh, “ultralytics/yolov5: v6.1—TensorRT, TensorFlow Edge TPU and OpenVINO Export and Inference,” February 2022.
[18]W. Liu, D. Anguelov, D. Erhan, C. Szegedy, S. Reed, C.-Y. Fu, and A. C. Berg, “Ssd: Single shot multibox detector,” in European conference on computer vision, pp. 21-37, Springer, 2016.
[19]K. Simonyan and A. Zisserman, “Very deep convolutional networks for large-scale image recognition,” arXiv preprint arXiv:1409.1556, 2014.
[20]C. Szegedy, W. Liu, Y. Jia, P. Sermanet, S. Reed, D. Anguelov, D. Erhan, V. Vanhoucke, and A. Rabinovich, “Going deeper with convolutions,” in Proceedings of the IEEE conference on computer vision and pattern recognition, pp. 1-9, 2015.
[21]K. He, X. Zhang, S. Ren, and J. Sun, “Deep residual learning for image recognition,” in Proceedings of the IEEE conference on computer vision and pattern recognition, pp. 770-778, 2016.
[22]G. Huang, Z. Liu, L. Van Der Maaten, and K. Q. Weinberger, “Densely connected convolutional networks,” in Proceedings of the IEEE conference on computer vision and pattern recognition, pp. 4700-4708, 2017.
[23]A. G. Howard, M. Zhu, B. Chen, D. Kalenichenko, W. Wang, T. Weyand, M. Andreetto, and H. Adam, “Mobilenets: Efficient convolutional neural networks for mobile vision applications,” arXiv preprint arXiv:1704.04861, 2017.
[24]M. Sandler, A. Howard, M. Zhu, A. Zhmoginov, and L.-C. Chen, “Mobilenetv2: Inverted residuals and linear bottlenecks,” in Proceedings of the IEEE conference on computer vision and pattern recognition, pp. 4510-4520, 2018.
[25]G. Huang, D. Chen, T. L1, F. Wu, L. Van Der Maaten, and K. Q. Weinberger, “Multi-scale dense networks for resource efficient image classification,” arXiv preprint arXiv:1703.09844, 2017.
[26]Y. Li, A. Dua, and F. Ren, “Light-Weight RetinaNet for Object Detection on Edge Devices,” in 2020 IEEE 6th World Forum on Internet of Things (WF-IoT), pp. 1-6, IEEE, 2020
[27]Y. He, K. Song, Q. Meng, and Y. Yan, “An end-to-end steel surface defect detection approach via fusing multiple hierarchical features,” IEEE Transactions on Instrumentation and Measurement, vol. 69, no. 4, pp. 1493-1504, 2019. Publisher: IEEE.
[28]N. Carion, F. Massa, G. Synnaeve, N. Usunier, A. Kirillov, and S. Zagoruyko, “End-to-end object detection with transformers,” in European conference on computer vision, pp. 213-229, Springer, 2020.
[29]“Home I StEER Website.”
[30]A. L. Salman, “StEER—Hurricane Dorian: Field Assessment Structural Team (FAST-1) Early Access Reconnaissance Report (EARR),” October 2019. Publisher: DesignSafe-CI Type: dataset.
[31]D. Roueche, J. Cleary, K. Gurley, J. Marshall, J.-P. Pinelli, D. Prevatt, D. Smith, A. Alipour, K. Angeles, B. Davis, C. Gonzalez, A. Lenjani, H. Mulchandani, M. Musetich, A. Salman, T. Kijewski-Correa, I. Robertson, and K. Mosalam, “StEER—HURRICANE MICHAEL: FIELD ASSESSMENT TEAM 1 (FAT-1) EARLY ACCESS RECONNAISSANCE REPORT (EARR),” October 2018. Publisher: DesignSafe-CI Type: dataset.
[32]M. Tan and Q. Le, “Efficientnet: Rethinking model scaling for convolutional neural networks,” in International conference on machine learning, pp. 6105-6114, PMLR, 2019.

1. A method for detecting objects in an image, the method comprising:
receiving an input image comprising an object;
inputting the input image into a trained deep learning model; and
classifying, using the deep learning model, a state of the object, wherein the trained learning model comprises:
a feature extraction subnetwork comprising a plurality of convolutional layers and a plurality of pooling layers, wherein the feature extraction subnetwork is configured to extract a plurality of first feature maps from the image, each of the first feature maps having a different resolution;
a feature pyramid subnetwork comprising a plurality of convolutional layers, wherein the feature pyramid subnetwork is configured to receive the first feature maps from the feature extraction subnetwork and output a plurality of second feature maps; and
a detection subnetwork configured to receive the second feature maps from the feature pyramid subnetwork and output the state of the object.

2. The method of claim 1, wherein the object is a utility pole.

3. The method of claim 2, wherein classifying, using the deep learning model, the state of the object comprises determining whether the utility pole is intact, leaning, or fallen.

4. The method of claim 1, wherein the feature extraction subnetwork comprises at least one skip connection between layers of the feature extraction subnetwork.

5. The method of claim 4, wherein the at least one skip connection is a long connection between one of the convolutional layers and a pooling layer.

6. The method of claim 4, wherein the at least one skip connection is a short connection between one of the pooling layers and a concatenation layer.

7. The method of claim 1, wherein the feature extraction subnetwork comprises 10 convolutional layers.

8. The method of claim 1, wherein the feature pyramid subnetwork is configured to output the second feature maps by upsampling the first feature maps.

9. The method of claim 1, wherein the detection subnetwork comprises a classifier and a bounding box regressor.

10. The method of claim 1, wherein the convolutional layers of the feature extraction subnetwork comprise separable convolutional layers.

11. A system for detecting objects in an image, the system comprising: at least one processor and a memory operably coupled to the at least one processor, wherein the memory has computer-executable instructions stored thereon that, when executed by the processor, cause the processor to execute a trained deep learning model comprising:
a feature extraction subnetwork comprising a plurality of convolutional layers and a plurality of pooling layers, wherein the feature extraction subnetwork is configured to extract a plurality of first feature maps from an image;
a feature pyramid subnetwork comprising a plurality of convolutional layers, wherein the feature pyramid subnetwork is configured to receive the first feature maps from the feature extraction subnetwork and output a plurality of second feature maps; and
a detection subnetwork configured to receive the second feature maps from the feature pyramid subnetwork and output a state of the object.

12. The system of claim 11, wherein the object is a utility pole.

13. The system of claim 12, wherein classifying, using the deep learning model, the state of the object comprises determining whether the utility pole is intact, leaning, or fallen.

14. The system of claim 11, wherein the feature extraction subnetwork comprises at least one skip connection between layers of the feature extraction subnetwork.

15. The system of claim 14, wherein the at least one skip connection is a long connection between one of the convolutional layers and a pooling layer.

16. The system of claim 11, wherein the feature pyramid subnetwork is configured to output the second feature maps by upsampling the first feature maps.

17. A method for training a deep learning model, the method comprising:
receiving a set of digital images from a database, wherein each of the digital images is associated with a respective label; and
training the deep learning model using the set of digital images, wherein the step of training comprises minimizing a direct set prediction loss function.

18. The method of claim 17, further comprising augmenting the set of digital images by randomly flipping a plurality of digital images from the set of digital images along an axis.

19. The method of claim 17, further comprising augmenting the set of digital images by applying a gaussian blur to a plurality of digital images from the set of digital images.

20. The method of claim 17, wherein the direct set prediction loss function comprises a bipartite matching loss and a bounding box loss.
